(19) United States
(12) Patent Application Publication
(10) Pub. No.: US 2026/0318022 A1
(43) Pub. Date: Oct. 15, 2026

(54) Transportable Cleaning Device for Cleaning Ground Areas and Cleaning Method

(71) Applicant: Glatt Gesellschaft mit beschränkter Haftung, Binzen (DE)

(72) Inventors: Reinhard Nowak, Lörrach (DE); Mirko Nowak, Lörrach (DE); Ivo Nowak, Lörrach (DE)

(21) Appl. No.: 19/476,266

(22) PCT Filed: Mar. 6, 2024
(86) PCT No.: PCT/EP2024/055815

§ 371 Date: Oct. 17, 2025

(30) Foreign Application Priority Data
Apr. 20, 2023 (DE) 10 2023 110 078.5

(51) Int. Cl. E01H 1/08; B23K 26/361

(52) U.S. Cl. CPC E01H 1/08; B23K 26/361

(57) ABSTRACT

A transportable cleaning device which can be used to clean ground areas formed in particular by traffic surfaces and which includes a cleaning vehicle equipped with castor wheels that allow vehicle movement over the ground area to be cleaned. The cleaning device is equipped with a laser cleaning device which includes a laser radiation output unit located on board the cleaning vehicle, from which laser radiation can be emitted to perform a cleaning process, which can be generated by a laser of the laser cleaning device. A handle on the cleaning vehicle enables it to be guided in a targeted manner over the ground area to be cleaned.

### CROSS-REFERENCE TO RELATED APPLICATIONS

This application is the United States national phase of International Patent Application No. PCT/EP2024/055815 filed Mar. 6, 2024, and claims priority to German Patent Application No. 10 2023 110 078.5 filed Apr. 20, 2023, the disclosures of which are hereby incorporated by reference in their entireties.

### BACKGROUND

### Field

The invention relates to a transportable cleaning device for cleaning ground areas, in particular ground areas in the form of traffic surfaces that can be walked on and/or driven on. The invention also relates to a cleaning method for cleaning such ground areas.

### Description of Related Art

Outdoor or interior space ground areas are subject to heavy contamination sooner or later due to their upward orientation. This is especially true for walkable and/or drivable traffic surfaces due to their often high usage. To avoid impairing their usability or simply for aesthetic reasons, it is therefore advisable to thoroughly clean the surfaces of such ground areas from time to time. However, appropriate cleaning measures, which can be carried out using a high-pressure cleaner or brushes, for example, are very time-consuming and labour-intensive and are usually unable to remove grease or oil residues sufficiently. Repeated abrasive cleaning can also impair existing surface structures and increase the risk of slipping on traffic surfaces.

### SUMMARY

The invention is based on the problem of providing a transportable cleaning device with which any ground areas and in particular, traffic surfaces can be effectively and quickly cleaned of contaminants without risk of damage. Furthermore, an effective and cost-efficient cleaning method for cleaning the aforementioned ground areas is to be proposed.

To solve this problem, the invention provides a transportable cleaning device equipped with a cleaning vehicle that can be guided by hand and comprises a handle for this purpose, which has several castor wheels in the area of the bottom of the vehicle, that enable it to move over the ground area to be cleaned, wherein the transportable cleaning device is equipped with a laser cleaning device which comprises a laser designed to generate laser radiation and a laser radiation output unit located on board the cleaning vehicle and participating in its vehicle movement, wherein the laser can generate laser radiation which emits from a laser radiation exit area of the laser radiation output unit and can be directed in the area of the bottom of the vehicle to remove contaminants on a region located below the cleaning vehicle on the ground area to be cleaned.

The problem is further solved by a cleaning method, which is carried out using a transportable cleaning device designed in the aforementioned manner, wherein the cleaning vehicle performs a vehicle movement over the ground area to be cleaned with the laser activated, so that the ground area is irradiated by the laser radiation exiting at the laser radiation exit area below the cleaning vehicle, thereby removing contaminants from the ground area.

The transportable cleaning device enables mobile laser radiation cleaning of traffic surfaces and any other ground areas, which is characterised by time-saving application, high effectiveness and gentle treatment of the ground areas. The cleaning process takes place as the cleaning vehicle moves over the ground areas to be cleaned, wherein the laser radiation generated by the laser cleaning device, which is emitted by a laser radiation output unit designed as a part of the cleaning vehicle, hits the region of the ground area currently located under the cleaning vehicle and, through this irradiation, removes contaminants from the often also structured ground area. Existing contaminants such as layers of dirt, oil and grease stains or other persistent, localised residues of any kind can be gently removed by evaporation through the application of energy, without the need for mechanical means or additional cleaning aids. The cleaning process is therefore environmentally friendly and cost-effective. The intensity of the irradiation can be individually adjusted depending on the material of the ground area by selecting a suitable radiation energy and/or laser beam shape, either ex works or by means of an existing adjustment device, in order to achieve the best possible cleaning result. The laser can be designed to generate pulsed and/or continuous laser radiation, for example depending on the degree of contamination and the driving speed of the cleaning vehicle. Since the laser radiation output unit is located on board the cleaning vehicle and therefore always moves directly with the vehicle movement, a largely constant distance between the laser radiation exit area and the ground area to be cleaned can be ensured during cleaning runs, which guarantees consistent cleaning quality regardless of the operator's technical skills. The laser radiation output unit can be constantly aligned so that the emitted laser radiation always hits the ground area to be cleaned at a desired angle, enabling highly effective treatment that is gentle on the material. As the laser operates without media, contamination of the surroundings of the ground area to be cleaned by cleaning agents can also be avoided. The cleaning vehicle can be guided precisely and in the desired direction over the ground area to be cleaned at any time using the handle. The handling does not distinguish itself in any way from that of other hand-held vehicles such as transport vehicles or lawnmowers, so that operation is very simple and does not require any extensive training.

The ground area that can be cleaned using the cleaning device is, in particular, a traffic surface that can be walked on and/or driven on, although the cleanable ground areas may also be areas not used for traffic purposes, such as storage areas, marking areas, presentation areas or artistic areas. As a rule, the ground area to be cleaned is a floor area, but the cleaning device is also expediently suitable for cleaning flat roof areas, platform areas, stage areas or the like. The cleaning device can be used outdoors or in an interior space, for example to clean industrial floors.

Advantageous further developments of the invention are set out in the dependent claims.

In principle, the cleaning vehicle can be equipped with an integrated drive system that can be controlled by the operator, so that even longer cleaning distances can be covered without fatigue. However, a preferred cleaning vehicle that is designed to be driven purely manually is particularly cost-effective, wherein the handle not only serves to steer the cleaning vehicle in the desired direction, but also to manually initiate a pushing and/or pulling driving force to generate the vehicle movement.

The handle is expediently located in the area of the rear of the vehicle. The operator thus walks behind the cleaning vehicle and has a good view of the surrounding area to be cleaned at all times.

Easy handling of the cleaning vehicle is promised by a handle that is designed as a bow-shaped handle protruding from the vehicle chassis of the cleaning vehicle and comprises two upwardly protruding handle bars fixed to the vehicle chassis, between which a web-liked handling section extends, which can be grasped with the hands to guide and, if necessary, also to initiate a driving force.

In relation to a central vehicle longitudinal axis of the cleaning vehicle extending in one direction of travel, the handle may be asymmetrical in design so that the operator walking behind the cleaning vehicle can assume a position offset to the side of the cleaning vehicle. This facilitates cleaning work along walls or in safety areas, for example on railway platforms, which may not be entered. A comparable effect can be achieved with a handle that can be rotated at least in sections and can be fixed in either a symmetrical or asymmetrical working position.

The handle expediently has at least one manually operable manual actuation element that allows easy manual activation and deactivation of the laser. The manual actuation element, which is, for example, a hand lever, is part of a manual actuation device that is expediently mechanically coupled to the laser radiation output unit via a coupling device, so that the operating state of the laser can be influenced by acting on the laser radiation output unit. The coupling device can comprise, for example, a linkage and/or a Bowden cable.

A particularly cost-effective embodiment of the cleaning device is possible if the laser radiation output unit is designed as a compact laser pistol, which comprises a pistol main section with the laser radiation exit area and a pistol handle protruding transversely from the pistol main section. The pistol handle is assigned an operating control suitable for activating and deactivating the laser, which can be operated by selectively pressing or releasing it, comparable to the trigger of a firearm pistol.

When equipped with a laser pistol, the coupling device of the manual actuation device can advantageously be designed in such a way that it interacts with the operating control, which in principle can also be operated directly by hand, and in this way, the operating control can be operated remotely via the manual actuation element, even if the operating control is located in the cleaning vehicle in a place that is difficult or impossible to access.

The cleaning vehicle can be steered very easily while driving if the castor wheels are designed partly as swivel castor wheels and partly as non-swivelling fixed castor wheels. Preferably, there are a total of four castor wheels, two of which are designed as fixed castor wheels and two as swivel castor wheels. Expediently, the fixed castor wheels and the swivel castor wheels are spaced apart from each other in the axial direction of a central vehicle longitudinal axis extending in the direction of travel of the cleaning vehicle. In this case, the fixed castor wheels and the swivel castor wheels are each arranged in pairs at the same axial height, wherein the axial height refers to the position in the axial direction of the vehicle longitudinal axis.

It is considered advantageous if the cleaning vehicle comprises a laser radiation shielding device which shields at least the laser radiation exit area and thus also the laser radiation emitted there from the surroundings, with the exception of an area on the bottom of the vehicle which, when the cleaning vehicle is used as intended, faces downwards and allows the laser radiation to exit in order to perform a cleaning process.

The laser radiation shielding device expediently comprises a shielding housing which encloses a working chamber in an opaque manner and thus without any possibility of laser radiation escaping, wherein the laser radiation exit area is located within this working chamber. To enable cleaning measures, the shielding housing comprises a working opening that points exclusively downwards during a cleaning process in accordance with its intended use and faces the ground area to be cleaned, through which the laser radiation exiting within the working chamber at the laser radiation exit area can irradiate the ground area without damaging the immediate or wider surroundings.

The best possible safety without compromising cleaning effectiveness is provided by an advantageous embodiment in which the window is surrounded by a downwardly projecting, sleeve-shaped protective wall, which is at least partially and preferably entirely flexible and which, when the cleaning vehicle is used as intended, can rest against the ground area to be cleaned with its lower peripheral area, so that it can slide over the ground area while maintaining constant surface contact during vehicle movement. The flexibility enables automatic adaptation to the individual surface structures of the ground area and allows the flexible protective wall to make shielding contact with the ground area in both raised and recessed surface areas. A particularly good protective result can be achieved with a flexible protective wall whose flexibility consists of a brush structure. For example, a natural or synthetic textile material is used to create the brush structure.

It is preferable for the entire laser radiation output unit to be encapsulated in the working chamber and shielded from the surroundings.

For example, in order to facilitate maintenance work, but also to enable thorough internal cleaning of the cleaning vehicle if necessary, it is advantageous if the shielding housing comprises a cover that can be removed to access the working chamber, for example by completely removing it or by opening it up.

Lasers are generally classified into different laser classes according to their hazard potential. Class 1 lasers have the lowest hazard potential. In class 4 lasers, the accessible laser radiation is extremely dangerous due to its high intensity. For effective cleaning of the ground area, a laser belonging to class 4 in terms of intensity is recommended. In order for such a class 4 laser to be used without restriction even in the often heavily frequented regions surrounding the ground area to be cleaned, it is advantageous if the laser cleaning device is equipped with a class 4laser, but the laser radiation shielding device is designed in such a way that, due to the shielding measures taken, the laser cleaning device is only classified as the unproblematic laser class 1.

The laser radiation output unit expediently comprises a laser optic arranged upstream of the laser radiation exit area in the opposite direction to the radiation direction. With the aid of the laser optic, the shape and direction of the emitted laser radiation can be influenced and specified in particular.

For the sake of high stability, the cleaning vehicle is expediently equipped with a vehicle chassis on which both the castor wheels and the laser radiation output unit are mounted. The handle is also expediently attached to the vehicle chassis.

It is advantageous if the cleaning vehicle comprises a positioning device that allows the laser radiation output unit to be variably adjusted to a working position.

Particularly when a very high-power laser is used, it is expedient, due to the associated size, to design the laser as a separate part of the transportable cleaning device with respect to the cleaning vehicle. The laser can, for example, be designed as a portable stand-alone device or as a mobile device with its own castor wheels, so that it can be positioned away from the cleaning vehicle as required, wherein it is connected to the cleaning vehicle via a flexible line assembly for transmitting the laser light, so that the latter comprises a high degree of freedom of movement.

In the case of a laser with lower power or smaller dimensions and/or if the cleaning application also tolerates larger dimensions of the cleaning vehicle, the laser can be arranged together with the laser radiation output unit on board the cleaning vehicle so that both components of the laser cleaning device follow the vehicle movement of the cleaning vehicle.

It is preferable for the laser cleaning device to be additionally equipped with a suction device that enables the suction cleaning of ablation media produced during a cleaning process. Since the ablation media are at least predominantly gaseous in consistency, suction cleaning can effectively prevent pollution of the surroundings.

The suction device has a suction opening conveniently located in the area of the laser radiation output unit, which communicates with a suction power unit of the suction device and which, if a laser radiation shielding device is present, is conveniently located inside the working chamber. The suction power unit may be equipped with a filtering device and comprise a receiving space in which extracted particles are collected for later disposal.

In order to provide the electrical energy required to operate the laser cleaning device, the transportable cleaning device is expediently equipped with a suitable power source. The power source is, for example, an accumulator as a power storage device and/or a power generator. Depending on the embodiment of the transportable cleaning device, the power source can be located directly on board the cleaning vehicle or designed as a component independent of it. For example, the laser and the power source can be designed as independent entities independent of the cleaning vehicle.

To prevent injuries or damage due to improper use, it is advantageous if the cleaning vehicle comprises a safety device that prevents the laser from being activated under certain usage situations.

It is advantageous to equip the safety device with a ground detection device that prevents the laser from being activated when the cleaning vehicle is raised and its castor wheels are no longer resting on the ground. The ground detection device is designed in particular to detect a position of use of the cleaning vehicle with its castor wheels standing on the ground and a position of non-use of the cleaning vehicle with its castor wheels not standing on the ground. As long as the position of non-use is detected, the laser is expediently placed in a blocking state that prevents its activation. When the position of use is detected, the laser can be set to a standby state that allows its activation and is also set to this state, provided that the safety device does not contain any further safety components that prevent the standby state from being activated.

As a further safety component, the safety device may, for example, comprise a cover detection device in connection with a laser radiation shielding device having a cover, which is capable of detecting a closed state of the cover closing the working chamber and an open state of the cover making the working chamber accessible. As long as the open state is detected, the laser remains in a blocking state that prevents its activation. If the closed state is detected, the laser can be put into a standby state that allows its activation. If the cover detection device is combined with a ground detection device, it is expediently to have a signal-technical connection such that the laser is only put into the standby state when both the position of non-use of the cleaning vehicle and the closed state of the cover are currently detected.

In a preferred embodiment, the aforementioned ground detection device has a sensing wheel that is movable relative to the castor wheels in the height direction of the cleaning vehicle, which is provided for sensing the ground beneath the cleaning vehicle and which is constantly preloaded into a lowered locking state that protrudes downwards beyond the castor wheels, for example by a weight force and/or by a spring device. Through contact with the ground, the sensing wheel can be pushed up into an unlock position, wherein the unlock position causes the laser to be in a standby state and the locking state causes the laser to be in a blocking state. The setting is made in such a way that the sensing wheel is positioned in the unlock position at least substantially at the same height as the castor wheels, in other words, the sensing wheel and the castor wheels rest equally on the ground.

A preferred location for the sensing wheel is in the proximity of the laser radiation exit area, in particular transversely to the direction of travel next to the laser radiation exit area.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to the accompanying drawing. This shows:

FIG. 1 a preferred embodiment of the transportable cleaning device according to the invention in a side view, wherein the laser is designed as part of an entity separate from a cleaning vehicle, which is connected to the cleaning vehicle via line connections indicated by dashed lines, wherein both the cleaning vehicle and the entity are placed on a ground comprising the ground area to be cleaned,

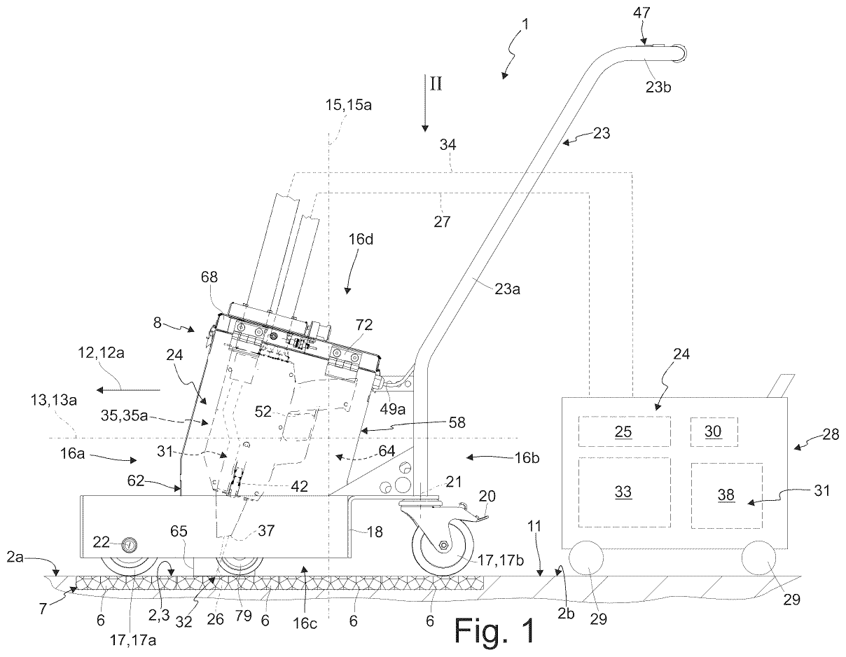

FIG. 2 the arrangement from FIG. 1 in a top view according to arrow II from FIG. 1, wherein the dotted line indicates an optional feature of the cleaning vehicle with the laser,

FIG. 3 a longitudinal section through the cleaning vehicle according to sectional plane III-III from FIG. 2, wherein the laser radiation output unit is only indicated by a dashed line and line connections extending from the top are also not shown, and

FIG. 4 a longitudinal section through the cleaning vehicle according to sectional plane IV-IV in the area of a ground detection device, wherein a movable sensing unit equipped with a sensing wheel is illustrated in solid lines in an unlock position and in dotted lines in a correspondingly lowered locking state.

### DETAILED DESCRIPTION

The drawing shows a transportable cleaning device with reference number 1, which is of preferred construction and serves to clean, any ground area 2 accessible from above.

The ground area 2 to be cleaned faces upwards in particular, wherein it may be aligned horizontally or diagonally in its entirety or in sections.

The ground area 2 that can be cleaned using the cleaning device 1 is, for example, a traffic surface 3 that can be walked on and/or driven on, although the ground area 2 that can be cleaned according to the invention may also be an area not used for traffic purposes, such as a storage area, marking area, presentation area or artistic area. As a rule, the ground area 2 to be cleaned is a floor area, but the cleaning device 1 is also suitable for cleaning non-floor areas such as flat roof areas, platform areas, stage areas or the like. The cleaning device 1 can be used outdoors or in an interior space, for example for cleaning industrial floors.

The ground area 2 that can be cleaned using the cleaning device 1 can, in principle, be of any type; for example, it can be a foundation surface 2a, such as a concrete surface or a screed surface, or a covering surface 2b, such as an asphalt surface, a paved surface, a tiled surface, a laminate surface, and so on. The drawing shows several paving stones 6 as an example, which define a paved surface 2b to be cleaned and are laid adjacent to a foundation surface 2a that is also to be cleaned, wherein the paved surface 2b and the foundation surface 2a represent a ground area to be cleaned.

Over time, the ground area 2, which is exposed to the weather and other external influences, can sometimes become significantly soiled, so that cleaning is desirable from time to time. The cleaning device 1 is designed to perform such cleaning.

The cleaning device 1 comprises a cleaning vehicle 8, which can be used to perform mobile laser radiation cleaning of the ground area 2. During its intended use, the cleaning vehicle 8 assumes a position of use as shown in the drawing, in which it stands on a ground 11 formed by the ground area 2, and can be moved on this ground 11 and thus also over the ground area 2 by performing a vehicle movement 12 indicated by an arrow. As mentioned above, the ground area 2 is formed, for example, by the foundation surface 2a and the covering surface 2b.

The cleaning vehicle 8 has a central vehicle longitudinal axis 13 defining a longitudinal direction of the vehicle 13a, wherein the vehicle movement 12 generally takes place in a direction of travel 12a coinciding with the longitudinal direction of the vehicle 13a. The cleaning vehicle 8 also has a vehicle transverse axis 14 orthogonal to the vehicle longitudinal axis 13 and a vehicle high axis 15 orthogonal to the vehicle longitudinal axis 13 and the vehicle transverse axis 14, which is usually aligned at least substantially vertically when the cleaning vehicle 8 is in use.

The cleaning vehicle 8 has a front of the vehicle 16a oriented in the longitudinal direction 13a of the vehicle, a rear of the vehicle 16b opposite to this, a bottom of the vehicle 16c facing the ground 11 in the position of use, and a top of the vehicle 16d facing upwards and opposite the bottom of the vehicle 16c.

The cleaning vehicle 8 is equipped with several castor wheels 17, with which it stands on the ground 11 in the position of use and which roll on the ground 11 when a vehicle movement 12 is performed. The vehicle movement 12 is possible in particular both as forward driving and as reverse driving.

The cleaning vehicle 8 preferably has four castor wheels 17, two of which are designed as fixed castor wheels 17a and two as swivel castor wheels 17b in the embodiment. The cleaning vehicle 8 expediently has a vehicle chassis 18 on which the castor wheels 17 are rotatably arranged by means of suitable suspension measures. For example, the two fixed castor wheels 17a are located in the area of the front of the vehicle 16a and the two swivel castor wheels 17b are located in the area of the rear of the vehicle 16b. The fixed castor wheels 17a and the swivel castor wheels 17b are thus arranged at a distance from each other in the longitudinal direction 13a of the vehicle. Both the two fixed castor wheels 17a and the two swivel castor wheels 17b are expediently located at the same height in the longitudinal direction 13a of the vehicle and, in particular, at the same distance on opposite sides of the vehicle longitudinal axis 13 extending through the centre of the vehicle.

The swivel castor wheels 17b can each be rotated relative to the vehicle chassis 18 about an axis of rotation 21 parallel to the vehicle high axis 15 in order to perform a desired steering movement. Steering is performed by manually applying force to a handle 23, which will be explained later. Each swivel castor wheel 17b is expediently equipped with a parking brake 20 for fixing the cleaning vehicle 8 in place at the desired location on the ground 11.

The fixed castor wheels 17a cannot be swivelled. They can only roll around a bearing shaft 22 that is parallel to the vehicle's transverse axis 14.

It goes without saying that the castor wheels 17 can also be present in a different number and in a different distribution pattern. For example, the cleaning vehicle 8 could be designed with three wheels.

The exemplary cleaning vehicle 8 does not have its own drive device for generating the vehicle movement 12. It is designed for purely manual initiation of the vehicle movement 12 and is therefore particularly cost-effective. For example, it comprises a handle 23, briefly mentioned above, attached to the vehicle chassis 18 in the area of the rear of the vehicle 16b, which can be grasped by an operator to manually initiate a pushing and/or pulling driving force with their hands.

The handle 23 also serves to guide the cleaning vehicle, i.e. in particular to specify the direction of the vehicle movement 12.

According to a non-illustrated embodiment, the cleaning vehicle 8 may be equipped with a motorised drive device to generate the vehicle movement. In this case, it comprises, in particular, a drive motor designed as a combustion engine or electric motor, which can act on at least one of the castor wheels 17 arranged in the area of the bottom of the vehicle 16c in order to cause the vehicle movement 12.

Preferably, the handle 23 is located in the area of the rear of the vehicle 16b so that it can be easily grasped by an operator standing behind the cleaning vehicle 8 and pushed forward by this operator.

For example, handle 23 is a bow-shaped handle extending upwards from the lower vehicle chassis 18, which comprises two handle bars 23a, in particular in the form of holms, spaced apart from each other in the axial direction of the vehicle transverse axis 14, referred to as the vehicle transverse direction 14a, which are each attached to the vehicle chassis 18 at a lower end region and are connected to each other at their upper end region by a horizontal web-like handling section 23b. The handling section 23b is used to grip with the hands for the purpose of guiding the cleaning vehicle 8.

For example, handle 23 is symmetrically designed with respect to a center plane 39 spanning the central vehicle longitudinal axis 13 and the vehicle high axis 15. However, deviating from this, it can be designed asymmetrically with respect to the vehicle longitudinal axis 13 of the vehicle or, more precisely, with respect to the aforementioned center plane 39, as indicated by the dotted lines at 23, 23c. This allows the cleaning vehicle 8 to be conveniently guided in a position offset in the vehicle transverse direction 14a of the vehicle relative to the operator. Alternatively, the handle 23 could be rotatable in the vehicle transverse direction 14a at least in a grip section comprising the handling section 23b, in order to position it in different transverse positions. These transverse positions can be releasably locked in particular by means of a locking device of the cleaning vehicle 8.

The cleaning device 1 is equipped with a laser cleaning device 24, which is designed to irradiate and thus treat the ground area 2 with laser radiation 26 generated by a laser 25 belonging to the laser cleaning device 24 in order to remove contaminants. Due to the laser radiation treatment, this involves in particular the thermal removal of contaminants, in particular in that the contaminants are at least predominantly vaporised by the energy of the laser radiation 26.

Laser radiation cleaning takes place during a vehicle movement 12 of the cleaning vehicle 8, which can also be referred to as a cleaning run, over the ground area 2 to be cleaned, which is carried out when the laser 25 is activated. The laser 25 can be set to either an activated or deactivated operating state, wherein laser radiation 26 is generated in the activated operating state and no laser radiation is generated in the deactivated operating state. The operating state of the laser 25 can be specified by a person operating the cleaning device 1.

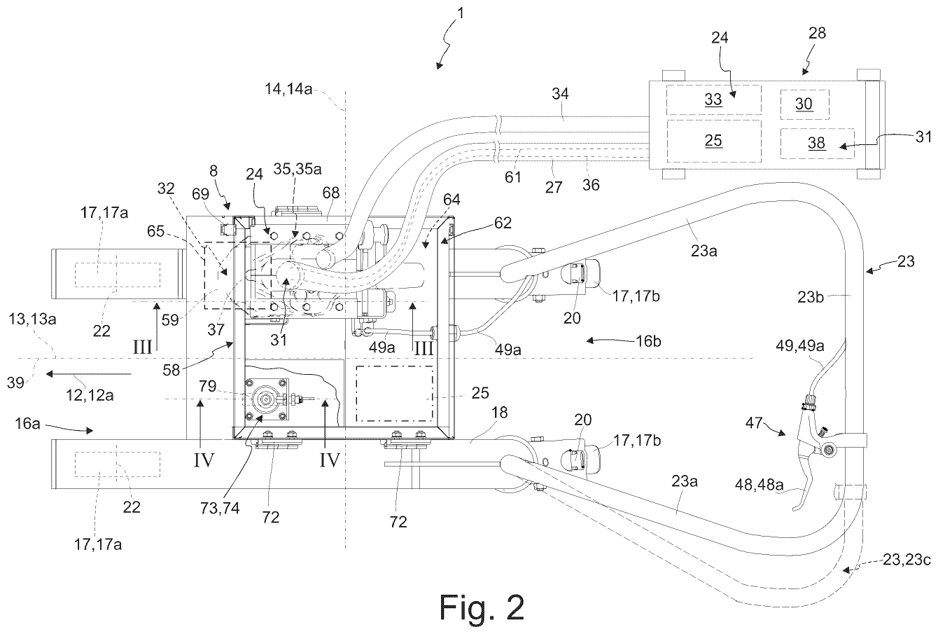

The laser 25 may be an integral part of the cleaning vehicle 8, as shown in the dotted illustration in FIG. 2, and may follow its vehicle movement 12. However, according to the preferred embodiment shown in solid lines, the laser 25 is designed separately from the cleaning vehicle 8, which offers the possibility of using a high-power laser 25 with correspondingly larger dimensions without impairing the manoeuvrability of the cleaning vehicle 8. The laser 25, which is designed as a stand-alone device, is connected to the cleaning vehicle 8 via a flexible line assembly 27, wherein the flexible line assembly 27 is intended, among other things, to forward the laser radiation generated by the laser 25 to the cleaning vehicle 8 for its intended use.

The laser 25, which is designed separately for the cleaning vehicle 8, is preferably part of a structural unit referred to below as a transportable entity 28, which is placed at a distance from the cleaning vehicle 8 during use of the cleaning vehicle 8, wherein a flexible line assembly 27 of sufficient length ensures a sufficient radius of movement for the cleaning vehicle 8.

The entity 28 can be equipped with wheels 29 so that it can be conveniently moved along with the cleaning vehicle 8 from time to time. The entity 28 is designed in particular as a mobile entity 28 which, like the cleaning vehicle 8 and at the same time independently of the cleaning vehicle 8, can be moved on the ground 11.

In a simple configuration of the cleaning device 1, the entity 28 contains only the laser 25 and any components that may be required to control it, in particular an electronic control device 30.

It is advantageous if the laser cleaning device 24 is equipped with a suction device 31, through which media referred to as ablation media, which are produced during a cleaning process in the working area 32 of the laser radiation 26, can be extracted in order to avoid contamination of the surroundings, in particular dust and odour contamination. The laser cleaning device 24 comprises such a suction device 31 as an example.

The suction device 31 contains an electrically operated suction power unit 33 for generating the desired suction effect, which is expediently designed as a further part of the entity 28. A flexible suction pipe 34 establishes a connection between the suction power unit 33 and the cleaning vehicle 8. It is designed separately from the flexible line assembly 27, but can also be an integral part of this flexible line assembly 27.

Depending on the size of the cleaning vehicle 8, the suction power unit 33 can alternatively also be a direct part of the cleaning vehicle 8.

The laser radiation 26 for treating the ground area 2 is emitted by a laser radiation output unit 35 located on board the cleaning vehicle 8 and therefore always moving with the vehicle 12, as shown in the drawing by the dotted line, which is a further part of the laser cleaning device 24. The flexible line assembly 27 connects the laser 25 to the laser radiation output unit 35 and contains at least one optical connecting line 36 for transmitting the laser light, which is preferably designed as a fibre optic cable.

The laser radiation output unit 35 has a laser radiation exit area 37, which is arranged in the area of the bottom of the vehicle 16c and allows the laser radiation 26 that can be generated or is generated by the laser 25 to exit. The laser radiation exit area 37 is aligned in the position of use of the cleaning vehicle 8 so that it faces the ground 11 located beneath the cleaning vehicle 8. The above-mentioned working area 32 is the area in which the laser radiation 26 exiting the laser radiation exit area 37 hits the ground area 2 to be cleaned.

In order to provide the electrical energy required to operate the laser 25, the laser cleaning device 24 is expediently equipped with a suitable power source 38. This power source 38 is, for example, a rechargeable accumulator for storing electricity or a power generator, such as a diesel generator. A accumulator and a power generator can also be combined to enable longer-lasting, off-grid operation.

The power source 38 also expediently supplies the electrical energy for operating the suction device 31.

The laser radiation output unit 35 preferably comprises a schematically indicated laser optic 42, which is responsible in particular for the radiation geometry of the laser radiation 26 exiting at the laser radiation exit area 37 and ensures, for example, that the laser radiation 26 hits the ground area 2 to be cleaned in a point-shaped or line-shaped manner. The laser optic 42 is located within the laser radiation output unit 35 and is positioned upstream of the laser radiation exit area 37 in the opposite direction to the radiation direction.

Preferably, the laser radiation output unit 35 is attached directly or indirectly to the preferably existing vehicle chassis 18 in any manner. Consequently, the laser radiation output unit 35 is supported by the vehicle chassis 18, which ensures high structural stability of the cleaning vehicle 8. A fastening device 43 used to fasten the laser radiation output unit 35 comprises, for example, a fixing bracket 45 into which the laser radiation output unit 35 is at least partially inserted.

It is advantageous if the fastening device 43 allows variable positioning of the laser radiation output unit 35 relative to the castor wheels 17 and, accordingly, also relative to the optional vehicle chassis 18. This advantage applies, for example, because the fastening device 43 is designed here as a positioning device 44 that allows the aforementioned positioning. This design results, for example, from the fact that the fixing bracket 45 is connected to the vehicle chassis 18 by means of fastening screws 46 and can be moved and/or pivoted relative to the vehicle chassis 18 when the fastening screws 46 are loosened. This offers the advantageous possibility of positioning the laser radiation exit area 37 at different height positions and/or in different angular orientations.

The cleaning vehicle 8 is expediently equipped with a manual actuation device 47, which allows convenient manual activation and deactivation of the laser 25 by the operator driving the cleaning vehicle 8.

The manual actuation device 47 comprises a manually operable manual actuation element 48 arranged on the handle 23, which is mechanically coupled to the laser radiation output unit 35 via a coupling device 49 and which can be used to trigger an operating process on the laser radiation output unit 35, whereby the laser 25 can be activated or deactivated.

For example, the manual actuation element 48 is a hand lever 48a that can be operated with one hand and is connected via a Bowden cable 49a of the coupling device 49 to a movable operating control 52 of the laser radiation output unit 35. By selectively pulling or releasing the hand lever 48a, the operating control 52 can be actuated and, accordingly, the laser 25 can be switched on and off.

In a non-illustrated embodiment, a bow-shaped manual actuation element 48 extending parallel to the handling section 23b is pivotably attached to the upper end region of the handle 23 and is coupled to the operating control 52 via a Bowden cable 49a.

Instead of the Bowden cable 49a, a linkage could also be provided, for example.

In any case, the manual actuation device 47 enables convenient remote actuation of the operating control 52 arranged on the laser radiation output unit 35.

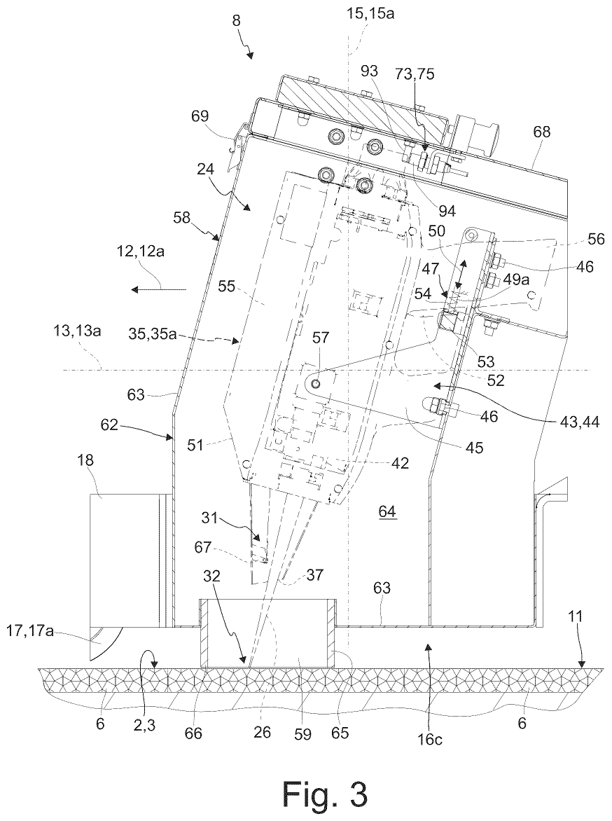

The laser radiation output unit 35 has, for example, an housing referred to below as the output unit housing 51, from which the operating control 52 protrudes. This operating control 52 can be operated by selectively pressing or releasing it, wherein it activates the laser 25 when pressed and deactivates it when not pressed. The coupling device 49 has an actuating element 53 adjacent to the operating control 52, which is attached, for example, to the Bowden cable 49a and is biased by a spring device 54 into an unactuated state in which the operating control 52 is not subjected to any pressing force. By actuating the manual actuation element 48, the actuating element 53 can also be switched to an actuated state, in which it holds the operating control 52 pressed. The switch movement 50 of the actuating element 53 that takes place here is illustrated in FIG. 3 by a double arrow.

In an embodiment not illustrated, the operating control 52 is arranged inside the output unit housing 51 and the coupling device 49 extends into the output unit housing 51.

The laser radiation output unit 35 is designed, for example, as a laser pistol 35a, which comprises an elongated pistol main section 55 and a pistol handle 56 extending transversely from the pistol main section 55. The operating control 52 is located in the area of the pistol handle 56. The laser pistol 35a is fixed to the fixing bracket 45 in the area of the pistol main section 55, among other places. An associated fixing area 57 can cause the laser pistol 35a to be pivotally mounted about an axis of rotation parallel to the vehicle transverse axis 14 in order to easily perform the above-mentioned adjustment measure by means of the positioning device 44.

Preferably, the cleaning vehicle 8 comprises an overall laser radiation shielding device designated by reference numeral 58, which prevents hazardous laser radiation 26 from escaping from the cleaning vehicle 8 in a manner that could endanger persons. The laser radiation shielding device 58 shields the laser radiation exit area 37 all around, with the exception of an area located on the bottom of the vehicle 16c, in which there is a window 59 through which the laser radiation 26 can exit to irradiate the ground area 2.

For example, the laser radiation shielding device 58 comprises a shielding housing 62 which has a housing wall 63 that is opaque at least in the vicinity of the laser radiation exit area 37. The housing wall 63 encloses a housing chamber designated as the working chamber 64, in which the laser radiation exit area 37 is located. For example, the entire laser radiation output unit 35 is preferably accommodated in the working chamber 64 and fixed to the inside of the housing wall 63 via the fastening device 43, which is attached to the vehicle chassis 18 or forms part of the vehicle chassis 18.

The housing wall 63 encloses the working chamber 64, in particular at the top 16d of the vehicle and also all around at the front, rear and sides. The working chamber 64 is also largely confined by the housing wall 63 at the bottom 16c of the vehicle, wherein only an area defining the window 53 is open.

The window 59 is preferably positioned so that it is as close as possible to the ground 11 during a cleaning run. This ensures that the reflected laser radiation 26 is reflected back into the working chamber 64 and is not emitted into the surroundings of the cleaning vehicle 8.

The exemplary cleaning vehicle 8 has an embodiment that allows the window 59 to be located practically directly on the ground area 2 to be cleaned. This is achieved by the housing wall 63 in the area of the window 59 being framed by a downwardly projecting sleeve-shaped protective wall 65, which has at least partially flexible properties and projects downward in an axial direction of the vehicle high axis 15, referred to as the vehicle height direction 15a. A lower annular peripheral area 66 of the protective wall 65 is arranged at such a height level relative to the castor wheels 17 that, in the position of use of the cleaning vehicle 8, it rests against the ground 11 beneath the cleaning vehicle 8 and thus against the region of the ground area 2 currently located there. During the vehicle movement 12, the protective wall 65 can slide over the ground area 2 with its peripheral area 66 due to its flexibility, while maintaining contact with the ground area 2. In this way, unwanted escape of laser radiation 26 can be reliably prevented.

The protective wall 65 is expediently designed to be flexible, at least in the lower peripheral area 66. For example, it is designed as a flexible protective wall 65 overall. The flexibility results in particular from an embodiment as an opaque brush structure.

The at least partially flexible protective wall 65 is equipped in particular in such a way that, when the cleaning vehicle 8 is not parked on a ground 11, it protrudes beyond a plane that can be designated as the contact plane, which is determined by the contact surfaces of the castor wheels 17 with which the castor wheels 17 are placed on the ground 11 in the position of use of the cleaning vehicle 8. In the position of use of the cleaning vehicle 8, the protective wall 65 is therefore pressed slightly upwards and rests on the ground 11 with a certain amount of pre-load, wherein it adopts the surface structure of the ground 11 in the contact area.

The sleeve-shaped protective wall 65 preferably comprises a rectangular and, in particular, square cross-sectional contour, but in principle it can also be round and, in particular, circular in contour.

In order to be able to remove even strongly adhering contaminants from surface 4, the laser 25 has a high intensity, in particular in that the laser 25 falls into laser class 4. However, due to the encapsulation described above by means of the laser radiation shielding device 58, the laser cleaning device 24 as a whole is classified as laser class 1 in terms of its operational status. In this way, cleaning runs can be performed with high laser energy and correspondingly high thoroughness without having to take into account the fact that cleaning runs are performed on public traffic surfaces 3 and, under certain circumstances, in areas heavily frequented by people.

The extraction performed by means of the suction device 31 takes place at least one suction opening 67 of the cleaning vehicle 8, which communicates with the suction pipe 34. The suction opening 67 is expediently located inside the working chamber 64 and preferably inside the laser radiation output unit 35. During operation of the suction power unit 33, a suction flow is formed between the suction opening 67 and the suction power unit 33, through which the removal media produced during laser cleaning are reliably extracted.

Particularly in the area of the top of the vehicle 16d, the shielding housing 62 expediently comprises a cover 68 which can be removed if necessary to allow access to the working chamber 64. At least one locking element 69 holds the cover 68 in a closed state as shown in the drawing. After manually unlocking the locking element 69, the cover 68 can be removed to assume an open state, for example by completely removing it from the remaining part of the shielding housing 62 or by pivoting it around a hinge mechanism 72.

The open state of the cover 68 allows, for example, the laser radiation output unit 35 to be installed and removed. The flexible line assembly 27 and the flexible suction pipe 34 are connected to the cleaning vehicle 8 in particular via the cover 68.

When the operating control 52 is actuated, electrical control signals are forwarded from the laser radiation output unit 35 to the control device 30 via at least one electrical signal line 61, which is designed as part of the flexible line assembly 27, and the control device 30 then specifies the operating state of the laser 25.

Preferably, the cleaning vehicle 8 is equipped with a safety device 73 which, depending on the situation, can prevent the laser 25 from being activated in order to avoid personal injury caused by laser radiation.

For example, the safety device 73 contains two components, namely a ground detection device 74 and a cover detection device 75, although only one component may be present.

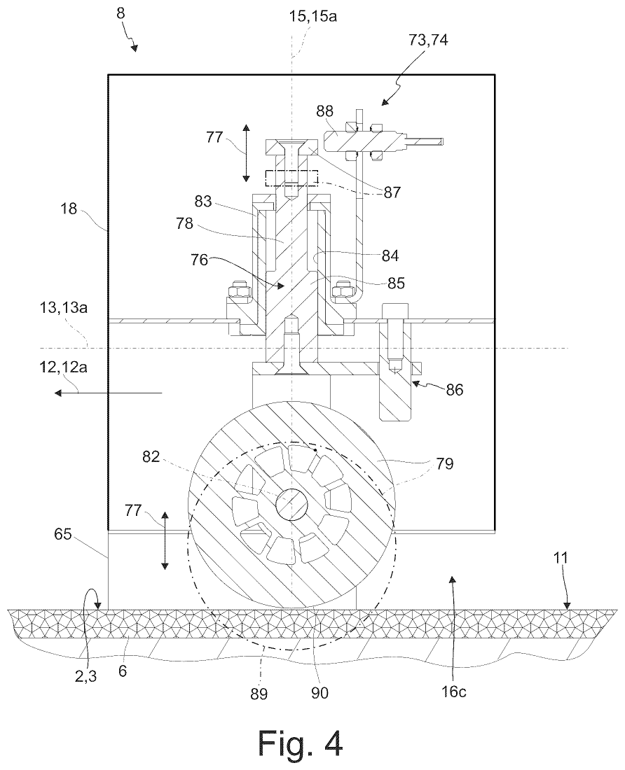

The ground detection device 74, which is particularly clearly visible in FIG. 4, is designed to detect the position of use, in which the castor wheels 17 are standing on the ground 11, and a position of non-use, in which the castor wheels 17 are not standing on the ground 11.

The cover detection device 75, which is particularly evident from FIG. 3, allows the closed state and the open state of the cover 68 to be detected.

The safety device 73 is connected via an electrical signal line, which is not further illustrated and is designed as part of the flexible line assembly 27, to the control device 30, which puts the laser 25 into a standby state that allows it to be activated, when the ground detection device 74 detects the position of use and the cover detection device 75 simultaneously detects the closed state of the cover 68. In a case where the ground detection device 74 defines the position of non-use of the cleaning vehicle 8 and/or the cover detection device 75 defines an open state of the cover 68, the laser 25 is placed in a blocking state by the control device 30, in which its activation is prevented. In the blocking state, therefore, actuation of the operating control 52 has no effect whatsoever.

According to the illustrated advantageous design, the ground detection device 74 has a sensing unit 76 that is movable relative to the castor wheels 17 and, accordingly, also relative to the vehicle chassis 18 in the vehicle height direction 15a. The movement that can be performed by the sensing unit 76 is referred to as the sensing movement 77 and is illustrated in FIG. 4 by double arrows. The sensing movement 76 is, for example, a linear movement, although in principle it could also be a swivel movement, for example.

The sensing unit 76 has a holding unit 78 and a sensing wheel 79 rotatably mounted on the holding unit 78. The sensing wheel 79 can rotate relative to the holding unit 78 about an axis of rotation 82 extending in the vehicle transverse direction 14a.

The sensing wheel 79 is located on the bottom of the vehicle 16c, specifically in an area between the four castor wheels 17.

The sensing unit 76 is movably mounted on the vehicle chassis 18 via the holding unit 78 to enable the sensing movement 77. For example, the holding unit 78 is movably mounted in a storage unit 83 attached to the vehicle chassis 18 in a manner that allows movement in the vehicle height direction 15a. For example, the storage unit 83 has a cylindrical guide hole 84 in which the holding unit 78 extends with a guide section 85 that has a cylindrical shape complementary to the guide hole 84. An optional anti-rotation device 86 ensures that the sensing unit 76 maintains its alignment with the axis of rotation 82 parallel to the vehicle transverse axis 14, regardless of its height position relative to the vehicle chassis 18.

The holding unit 78 has a trigger element 87, referred to below as the first trigger element 87 for better differentiation, which follows the sensing movement 77 and, during this sensing movement 77, performs a relative movement with respect to a position sensor 88 arranged in the vicinity and fixed in relation to the vehicle chassis 18, referred to below as the first position sensor 88 for the sake of differentiation.

Due to its weight, the sensing unit 76 and thus also the sensing wheel 79 are preloaded into a lowered locking state 89, which extends downwards beyond the castor wheels 17 and is indicated by dotted lines in FIG. 4. The locking state 89 is present when the cleaning vehicle 8 is lifted off the ground 11 with its castor wheels 17.

From the locking state 89, the sensing wheel 79 and, with it, the entire sensing unit 76 can be moved by the sensing movement 77 into an unlock position 90 illustrated by solid lines. The unlock position 90 is achieved by the sensing wheel 79 being pressed upwards by the ground 11 when the cleaning vehicle 8 is parked on said ground 11.

The sensing unit 76 is equipped, in particular, with the first trigger element 87 on the holding unit 78, which participates in the sensing movement 77 and in the vicinity of which the first position sensor 88 is arranged on the vehicle chassis 18. In the locking state 89, the first trigger element 87 is so far away from the first position sensor 88 that the latter is deactivated, which signals the position of non-use. In the unlock position 90, the first position sensor 88 is actuated by the first trigger element 87, so that a sensor signal signalling the position of use is output.

The unlock position 90 is characterised in particular by the fact that the sensing wheel 79 is positioned at least substantially at the same height as the castor wheels 17. More precisely, in the unlock position 90, the contact area between the sensing wheel 79 and the ground 11 lies at least substantially in the above-mentioned contact plane of the castor wheels 17.

Expediently, the sensing wheel 79 is arranged in the vicinity of the laser radiation exit area 37, wherein it is placed, for example, in the vehicle transverse direction 14a next to the laser radiation exit area 37. Preferably, the sensing wheel 79 and, in particular, the entire ground detection device 74 are located outside the working chamber 64.

The cover detection device 75 has, for example, a trigger element 93 arranged on the cover 68 and designated as a second trigger element 93 for better differentiation, and a position sensor 94 which is stationary relative to the vehicle chassis 18 and designated as a second position sensor 94 for better differentiation. When the cover 68 is in the closed position, the second position sensor 94 is actuated by the second trigger element 93, causing it to output a corresponding sensor signal to the control device 30. When the cover 68 is in its open state, the second trigger element 93 is removed from the second position sensor 94, so that no sensor signal is emitted, which is interpreted by the control device 30 as the cover 68 being closed.

The two position sensors 88, 94 are connected in the control device 30 in such a way that the laser 25 is only put into the standby state when the first position sensor 88 detects the position of use of the cleaning vehicle 8 and the second position sensor 94 detects that the cover 68 is in the closed state.

The detection measures mentioned are expediently carried out without contact. For example, the first and second trigger elements 87, 93 are each a permanent magnet and the first and second position sensors 88, 94 are each a proximity sensor that responds to a magnetic field, for example a Hall sensor.

It should be added that the sleeve-shaped protective wall 65 preferably comprises a rectangular and, in particular, square cross-sectional contour, but in principle it can also be round and, in particular, circular in contour.

1. A transportable cleaning device for cleaning ground areas in the form of traffic surfaces that can be walked on and/or driven on, comprising a cleaning vehicle that can be guided by hand and comprises a handle for guiding the cleaning vehicle, a plurality of castor wheels in the area of a bottom of the vehicle that enable a vehicle movement over the ground area to be cleaned, and a laser cleaning device which comprises a laser designed to generate laser radiation and a laser radiation output unit located on board the cleaning vehicle and participating in its vehicle movement, wherein the laser can generate laser radiation which emits from a laser radiation exit area of the laser radiation output unit and can be directed in the area of the bottom of the vehicle to remove contaminants on a region located below the cleaning vehicle on the ground area to be cleaned.

2. The transportable cleaning device according to claim 1, wherein the cleaning vehicle is designed for purely manual initiation of the vehicle movement, wherein the handle can be used to manually initiate a pushing and/or pulling driving force.

3. The transportable cleaning device according to claim 1, wherein the handle is arranged on the cleaning vehicle in the area of a rear of the vehicle.

4. The transportable cleaning device according to claim 1, wherein the handle is asymmetrical in relation to a central vehicle longitudinal axis extending in a direction of travel of the cleaning vehicle or can be aligned symmetrically or asymmetrically, at least in sections, by pivoting.

5. The transportable cleaning device according to claim 1, wherein at least one manually operable manual actuation element in the form of a hand lever of a manual actuation device serving to manually activate and deactivate the laser is arranged on the handle, which is mechanically coupled to the laser radiation output unit via a coupling device.

6. The transportable cleaning device according to claim 1, wherein the laser radiation output unit is designed as a laser pistol which comprises a pistol main section with a laser radiation exit area and a pistol handle extending transversely from the pistol main section, wherein the pistol handle is assigned an operating control which can be actuated by selectively pressing or releasing it and which enables the laser to be activated and deactivated.

7-9. (canceled)

10. The transportable cleaning device according to claim 1, wherein the cleaning vehicle comprises a laser radiation shielding device which shields the laser radiation exit area from the surroundings in an opaque manner, except for an area on the bottom of the vehicle which points downwards when the cleaning vehicle is used as intended.

11. The transportable cleaning device according to claim 10, wherein the laser radiation shielding device comprises a shielding housing which opaquely encloses a working chamber, wherein the laser radiation exit area is located and which comprises a window in the area of the bottom of the vehicle, through which laser radiation exiting within the working chamber at the laser radiation exit area can irradiate a ground area region of a ground area to be cleaned located under the cleaning vehicle.

12. The transportable cleaning device according to claim 11, wherein the window is surrounded by a downwardly projecting sleeve-shaped protective wall which has at least partially flexible properties and rests against the ground area to be cleaned with a lower peripheral area and can slide over the ground area to be cleaned during the vehicle movement while maintaining contact.

13. The transportable cleaning device according to claim 11, wherein the entire laser radiation output unit is arranged in the working chamber in an encapsulated manner with respect to the surroundings.

14. The transportable cleaning device according to claim 11, wherein the shielding housing comprises a cover that can be removed to access the working chamber.

15. The transportable cleaning device according to claim 10, wherein the laser belongs to laser class 4 with regard to the intensity of the laser radiation that can be generated by it, wherein the laser cleaning device as a whole is assigned to laser class 1 due to the laser radiation shielding device.

16. The transportable cleaning device according to claim 1, wherein the laser radiation output unit comprises a laser optic arranged upstream of the laser radiation exit area.

17. The transportable cleaning device according to claim 1, wherein the cleaning vehicle comprises a vehicle chassis on which both the castor wheels and the laser radiation output unit are arranged.

18. The transportable cleaning device according to claim 1, wherein the laser radiation output unit is assigned a positioning device of the cleaning vehicle, by means of which a working position of the laser radiation output unit within the cleaning vehicle can be variably adjusted.

19. (canceled)

20. (canceled)

21. The transportable cleaning device according to claim 1, wherein the laser cleaning device is equipped with a suction device for suction cleaning ablation media caused by the laser radiation during a cleaning process in the area of the laser radiation output unit.

22. (canceled)

23. (canceled)

24. The transportable cleaning device according to claim 1, wherein the cleaning vehicle comprises a safety device which prevents activation of the laser under certain usage situations of the cleaning vehicle.

25. The transportable cleaning device according to claim 24, wherein the safety device comprises a ground detection device by means of which a position of use of the cleaning vehicle standing with the castor wheels on a ground and a position of non-use of the cleaning vehicle wherein the castor wheels are not standing on a ground can be detected, wherein the laser can be set to a standby state enabling its activation as a result of detection of the position of use and to a blocking state preventing its activation as a result of detection of the position of non-use.

26. (canceled)

27. (canceled)

28. The transportable cleaning device according to claim 24, comprising a shielding housing that comprises a cover that can be removed to access a working chamber and the safety device comprises a cover detection device by means of which a closed state of the cover closing the working chamber and an open state of the cover making the working chamber accessible can be detected, wherein the laser can be set to a standby state enabling its activation as a result of detection of the closed state and to a blocking state preventing its activation as a result of detection of the open state.

29. A cleaning method for cleaning ground areas in the form of traffic surfaces that can be walked on and/or driven on, wherein a transportable cleaning device is used, wherein the transportable cleaning device comprises a cleaning vehicle that can be guided by hand and comprises a handle for guiding the cleaning vehicle by hand, a plurality of castor wheels in the area of a bottom of the vehicle that enable a vehicle movement over the ground area to be cleaned, and a laser cleaning device which comprises a laser designed to generate laser radiation and a laser radiation output unit located on board the cleaning vehicle and participating in its vehicle movement, wherein the laser can generate laser radiation which emits from a laser radiation exit area of the laser radiation output unit and can be directed in the area of the bottom of the vehicle to remove contaminants on a region located below the cleaning vehicle on the ground area to be cleaned, the method comprising: the cleaning vehicle performing a vehicle movement over the ground area to be cleaned with the laser activated, so that the ground area is irradiated by the laser radiation exiting at the laser radiation exit area below the cleaning vehicle, thereby removing contaminants from the ground area.
